(19) United States
(12) Patent Application Publication
(10) Pub. No.: US 2022/0318669 A1
(43) Pub. Date: Oct. 6, 2022

(54) TRAINING A MACHINE LEARNING MODEL USING STRUCTURED DATA

(71) Applicant: salesforce.com, inc., San Francisco, CA (US)

(72) Inventors: Zachary Alexander, Berkeley, CA (US); Na Cheng, Bellevue, WA (US); Jayesh Govindarajan, Palo Alto, CA (US)

(21) Appl. No.: 17/220,567

(22) Filed: Apr. 1, 2021

(51) Int. Cl. G06N 20/00; G06K 9/62

(52) U.S. Cl. CPC G06N 20/00; G06K 9/6256

(57) ABSTRACT

A computing system may receive a corpus of training data including a plurality of data entity schemas. A first data entity of a first set of data entities corresponding to a first data entity schema is associated with a topic characteristic based on a first set of attributes defined by the first data entity schema, and a first attribute of the first set of attributes is associated with a structural characteristic that is common across each of the first set of data entities. The system may identify a respective attribute type identifier for each attribute of the first set, generate an attribute embedding for each attribute using the attribute value and the identifier, generate an entity embedding based on each attribute embedding and parameterize the topic characteristic for each data entity and the structural characteristic for each attribute.

### FIELD OF TECHNOLOGY

The present disclosure relates generally to database systems and data processing, and more specifically to training a machine learning model using structured data.

### BACKGROUND

A cloud platform (i.e., a computing platform for cloud computing) may be employed by many users to store, manage, and process data using a shared network of remote servers. Users may develop applications on the cloud platform to handle the storage, management, and processing of data. In some cases, the cloud platform may utilize a multi-tenant database system. Users may access the cloud platform using various user devices (e.g., desktop computers, laptops, smartphones, tablets, or other computing systems, etc.).

In one example, the cloud platform may support customer relationship management (CRM) solutions. This may include support for sales, service, marketing, community, analytics, applications, and the Internet of Things. A user may utilize the cloud platform to help manage contacts of the user. For example, managing contacts of the user may include analyzing data, storing and preparing communications, and tracking opportunities and sales.

Since the cloud platform may support various services for a customer, the customer's contacts, and users associated with the various services, the cloud platform may maintain a rich dataset associated with the customer. The dataset may include millions of different objects or entities corresponding to various different object types that are used to support the various services such as sales, marketing, customer services, and the like.

### BRIEF DESCRIPTION OF THE DRAWINGS

FIG. 1 illustrates an example of a system that supports training a machine learning model using structured data in accordance with aspects of the present disclosure.

FIG. 2 illustrates an example of a system that supports training a machine learning model using structured data in accordance with aspects of the present disclosure.

FIG. 3 illustrates an example of a diagram that illustrates training a machine learning model using structured data in accordance with aspects of the present disclosure.

FIG. 4 illustrates an example of a model architecture that supports training a machine learning model using structured data in accordance with aspects of the present disclosure.

FIG. 5 illustrates an example of a process flow diagram that illustrates training a machine learning model using structured data in accordance with aspects of the present disclosure.

FIG. 6 shows a block diagram of an apparatus that supports training a machine learning model using structured data in accordance with aspects of the present disclosure.

FIG. 7 shows a block diagram of a model training manager that supports training a machine learning model using structured data in accordance with aspects of the present disclosure.

FIG. 8 shows a diagram of a system including a device that supports training a machine learning model using structured data in accordance with aspects of the present disclosure.

FIGS. 9 through 12 show flowcharts illustrating methods that support training a machine learning model using structured data in accordance with aspects of the present disclosure.

### DETAILED DESCRIPTION

In some examples, a cloud platform may support various services associated with a tenant of a multi-tenant system. The services may include marketing, communication, e-commerce, business to business (B2B), business to customer (B2C), services and various related services. Because the cloud platform may support these various services for a tenant, the cloud platform may maintain a rich dataset for the tenant. The dataset may include various entity schemas (e.g., data tables or other forms structuring data) that each include a set of entities. For example, the dataset may include a case entity schema or data table that includes a listing of a set of customer service cases. The case entity schema may define various attributes that define the case entity, such as case subject, description, conversation (e.g., a chat bot conversation), etc. Other types of entity schemas that may be associated with a tenant may include account entities, order entities, web behavior entities, etc. Thus, the dataset associated with a particular tenant of the multi-tenant system may include thousands of different entity types, each with hundreds of thousands or millions of instances (e.g., rows) of the entities.

Implementations described herein support techniques for leveraging the structured nature of such tenant data to train a machine learning model to support various services (e.g., artificial intelligence (AI) services) that may be used by the tenant. The techniques described herein support unsupervised domain-specific pre-training on the tenant data. The relevant domain for such unsupervised domain-specific pre-training, as described in more detail below, is the type of data and the inherent structure of data collected and stored as part of a customer relationship management (CRM) system. After the model is pre-trained using the techniques described herein, the model may be fine-tuned using more specific domain or task-specific data and/or used to support AI services.

As described herein, a tenant may be associated with a corpus of data, such as CRM data, which may have an inherent structure, organization, and or interrelationship that can be understood and leveraged for the purpose of unsupervised pre-training techniques. Although CRM data is used herein as an example of a type of data having a structure that can be leveraged for unsupervised domain-specific pre-training, it should be understood that other types of data having analogous structure or organization may also be used within the scope of the present disclosure. The corpus of data may include a one or more data entity schemas, where each data entity schema defines a set of attributes for a set of entities or objects corresponding to a particular data entity schema. One example of a data entity schema is a data table for an object, where the data table includes a set of columns. Each column of the table corresponds to an attribute and each row of the table corresponds to an instance of the entity. It should be understood that other types of entity representations or schemas are contemplated within the scope of the present disclosure. For example, data structures or schemas utilized in cloud-based data storage systems or in non-relational database systems may not be structured as data tables, but may still possess a metadata structure that includes corresponding aspects of entities, attributes, and instances as described herein.

Due to the nature of the organization of tenant data according to an entity schema (e.g., a data table), data within a particular row in a table may be inherently associated with a common topic or “aboutness,” which may be referred to as a topic characteristic herein. For example, each row of a case table, as described herein, is associated with a topic for the case (e.g., “forgot password”). Further, each column or attribute across a set of entities for a particular entity schema may be inherently associated with a style or structure, which may be referred to as a structural characteristic herein. For example, the value for a set of subject attributes of the case table may all include a small set of words/tokens (e.g., less than three tokens) that describe the subject of the case (e.g., “Password reset”).

The techniques described herein use a word embedding technique that supports capture of the topic characteristic for each instance of an entity and the structural characteristics for each attribute across the entities for a particular entity schema. For example, the system may identify an attribute type identifier, such as a column or field name for a particular attribute of a first entity schema. For a data entity (e.g., one row) of the entity schema, an attribute embedding (e.g., a vectorized representation) may be generated for each attribute by inputting the data for the entity into a word embedding function. The attribute embedding may be generated based on an attribute type identifier and an attribute value (e.g., the value of the column and row) for the attribute of the data entity. Further, an entity embedding may be generated using each attribute embedding corresponding to the data entity. When this process is performed for each entity (e.g., using the same attribute type identifiers across the entity), the topic characteristics (for each data entity) and structural characteristic (for each attribute) may be implicitly captured in the data model. Further, this technique may be performed across a large set of data entity schemas of the corpus of data corresponding to a tenant. Thus, the data model may function similar to a conditional language model, whereby the system receives an input including an attribute type identifier and an entity embedding for an entity, and the system may output an example value corresponding to the attribute for the attribute type identifier. Thus, this system may support various AI services that may be used by the tenant. These and other techniques are further described with respect to the figures.

Aspects of the disclosure are initially described in the context of an environment supporting an on-demand database service. Aspects of the disclosure are further described with respect to a system illustrating the model training techniques, a diagram illustrating the use and implementation of the trained model in the context of data used to train the model, a model architecture, and a process flow diagram illustrating model training and implementation. Aspects of the disclosure are further illustrated by and described with reference to apparatus diagrams, system diagrams, and flowcharts that relate to training a machine learning model using structured data.

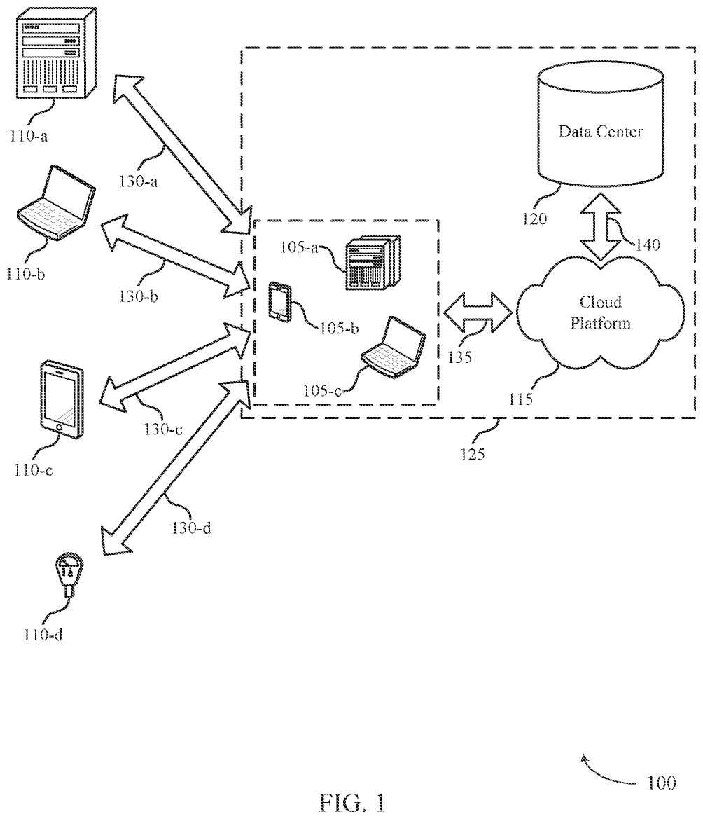

FIG. 1 illustrates an example of a system 100 for cloud computing that supports training a machine learning model using structured data in accordance with various aspects of the present disclosure. The system 100 includes cloud clients 105, contacts 110, cloud platform 115, and data center 120. Cloud platform 115 may be an example of a public or private cloud network. A cloud client 105 may access cloud platform 115 over network connection 135. The network may implement transfer control protocol and internet protocol (TCP/IP), such as the Internet, or may implement other network protocols. A cloud client 105 may be an example of a user device, such as a server (e.g., cloud client 105-a), a smartphone (e.g., cloud client 105-b), or a laptop (e.g., cloud client 105-c). In other examples, a cloud client 105 may be a desktop computer, a tablet, a sensor, or another computing device or system capable of generating, analyzing, transmitting, or receiving communications. In some examples, a cloud client 105 may be operated by a user that is part of a business, an enterprise, a non-profit, a startup, or any other organization type.

A cloud client 105 may interact with multiple contacts 110. The interactions 130 may include communications, opportunities, purchases, sales, or any other interaction between a cloud client 105 and a contact 110. Data may be associated with the interactions 130. A cloud client 105 may access cloud platform 115 to store, manage, and process the data associated with the interactions 130. In some cases, the cloud client 105 may have an associated security or permission level. A cloud client 105 may have access to applications, data, and database information within cloud platform 115 based on the associated security or permission level, and may not have access to others.

Contacts 110 may interact with the cloud client 105 in person or via phone, email, web, text messages, mail, or any other appropriate form of interaction (e.g., interactions 130-a, 130-b, 130-c, and 130-d). The interaction 130 may be a business-to-business (B2B) interaction or a business-to-consumer (B2C) interaction. A contact 110 may also be referred to as a customer, a potential customer, a lead, a client, or some other suitable terminology. In some cases, the contact 110 may be an example of a user device, such as a server (e.g., contact 110-a), a laptop (e.g., contact 110-b), a smartphone (e.g., contact 110-c), or a sensor (e.g., contact 110-d). In other cases, the contact 110 may be another computing system. In some cases, the contact 110 may be operated by a user or group of users. The user or group of users may be associated with a business, a manufacturer, or any other appropriate organization.

Cloud platform 115 may offer an on-demand database service to the cloud client 105. In some cases, cloud platform 115 may be an example of a multi-tenant database system. In this case, cloud platform 115 may serve multiple cloud clients 105 with a single instance of software. However, other types of systems may be implemented, including—but not limited to—client-server systems, mobile device systems, and mobile network systems. In some cases, cloud platform 115 may support CRM solutions. This may include support for sales, service, marketing, community, analytics, applications, and the Internet of Things. Cloud platform 115 may receive data associated with contact interactions 130 from the cloud client 105 over network connection 135, and may store and analyze the data. In some cases, cloud platform 115 may receive data directly from an interaction 130 between a contact 110 and the cloud client 105. In some cases, the cloud client 105 may develop applications to run on cloud platform 115. Cloud platform 115 may be implemented using remote servers. In some cases, the remote servers may be located at one or more data centers 120.

Data center 120 may include multiple servers. The multiple servers may be used for data storage, management, and processing. Data center 120 may receive data from cloud platform 115 via connection 140, or directly from the cloud client 105 or an interaction 130 between a contact 110 and the cloud client 105. Data center 120 may utilize multiple redundancies for security purposes. In some cases, the data stored at data center 120 may be backed up by copies of the data at a different data center (not pictured).

Subsystem 125 may include cloud clients 105, cloud platform 115, and data center 120. In some cases, data processing may occur at any of the components of subsystem 125, or at a combination of these components. In some cases, servers may perform the data processing. The servers may be a cloud client 105 or located at data center 120.

As described the cloud platform 115 may support various tenants (e.g., contacts 110) as well as services associated with such tenants. Additionally, the data center 120 in conjunction with the cloud platform 115 may maintain a significant set of tenant data, and the data set may be used by the tenants to support the various customer services. The data set may include data that corresponds to customer cases, work orders, accounts, conversations, articles, and other similar data associated with customer interaction with tenant services. Accordingly, the data is rich in customer related topical content and structure, which may support various AI services.

Some systems may use unsupervised domain-specific pre-training on the domain of natural language (referred to as unsupervised language model pre-training) to train models for AI services. One such example includes techniques related to the bidirectional encoder representations from transformers (BERT) pre-training technique to generate word embeddings for a corpus of data. The BERT technique accounts for the context of each embedding. For example, BERT may provide a different embedding for the same text string occurring in two different sentences, wherein the different embeddings are due to the context of the occurrences. These techniques have been tested and applied to corpuses of unstructured texts including books and online encyclopedia articles. However, the unstructured text may not support models that may be more accurate when trained on structured text, such as CRM data.

Implementations described herein provide the cloud platform 115 that supports formulating the inputs and the outputs of an unsupervised machine learning pre-training model in a manner that leverages the structured and interrelated nature of the CRM data (or other data that is organized in similar way), which may be stored and managed at data center 120. The model may receive an input that includes a collection of attributes corresponding to a data entity. A data entity may be an example of an instance of a row of a data table (e.g., an object), where each attribute corresponds to a field or column. Each attribute may include text or numbers or other structured data (e.g., dates, fields, etc.). The system may generate one embedding corresponding to the entire input (e.g., the collection of attributes), one embedding corresponding to each attribute, and one embedding corresponding to each token of an attribute (e.g., each word of a plain text attribute). Further, the system may concatenate the attribute name (e.g., column name) and the unstructured text to support decoding or a conditional language model. These techniques capture the structure in the data in that each instance of an entity may be related to a “topic” or “aboutness” and that each attribute type for a set of entities is related in the “style” or “structure.” These characteristics of the data, by virtue of its organization in tables with known relationships and implied styles and consistent formats, can be leveraged to build a machine learning model pre-trainer that is unique due to its application in and configuration for a different domain. This technique may support a variety of downstream AI services by further training the model with more domain-specific inputs.

In one example utilization of the techniques described herein, a model may be pre-trained on data associated with a particular tenant (e.g., contact 110) and using the techniques described herein. The data may include a set of objects corresponding to cases, which is data that includes chat correspondence between a customer and a customer service agent. The cases may be related to delivery information, password reset, order information, etc. A chatbot AI service that is trained using the model may leverage such data to support automated chat experiences with customers. As a customer enters an utterance (e.g., textual input), the utterance may be converted to an embedding and compared to the model data. The model data may be used to identify one of the sets of potential topics as well as an article or other input that may be used to resolve the customer inquiry. Due to the structural nature of the tenant data, the model may be able to identify an accurate and useful response to the customer inquiry.

It should be appreciated by a person skilled in the art that one or more aspects of the disclosure may be implemented in a system 100 to additionally or alternatively solve other problems than those described above. Furthermore, aspects of the disclosure may provide technical improvements to “conventional” systems or processes as described herein. However, the description and appended drawings only include example technical improvements resulting from implementing aspects of the disclosure, and accordingly do not represent all of the technical improvements provided within the scope of the claims.

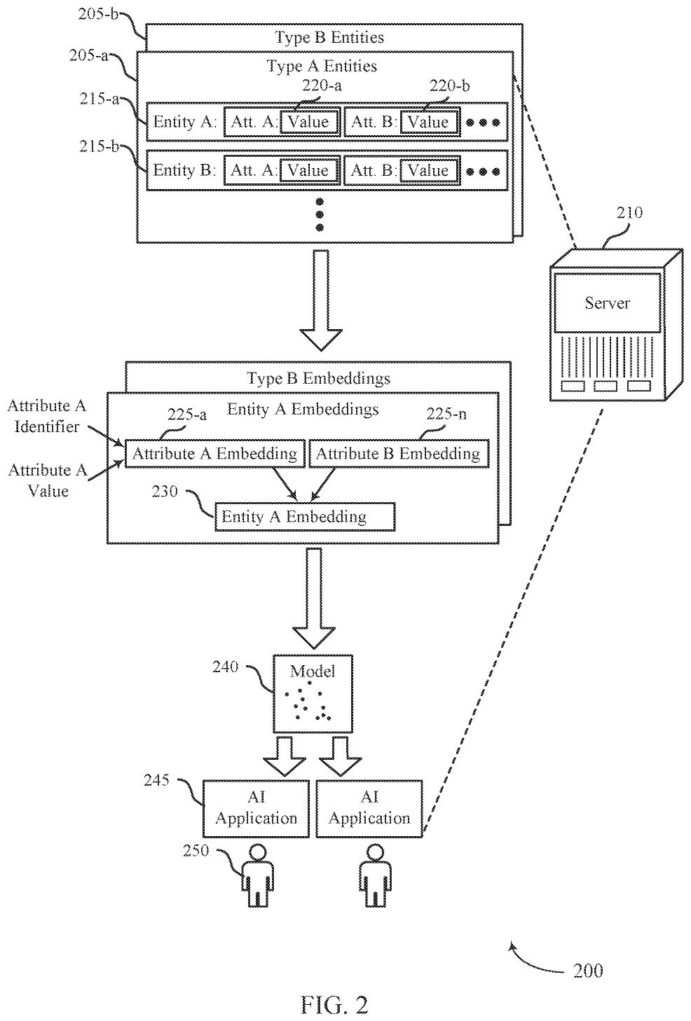

FIG. 2 illustrates an example of a system 200 that supports training a machine learning model using structured data in accordance with aspects of the present disclosure. The system 200 includes a server 210, which may represent various different logical and physical computing components. The server 210 may access or support datastores (e.g., datacenter 120 of FIG. 1) that manage and store data associated with one or more tenants of a multitenant system. As such, various services that are implemented or used by the one or more tenants may be configured to access, modify, and add data for the one or more tenants. Example services may include communication services, marketing services, e-commerce services, and other related services. Due to such data corresponding to a particular tenant and associated services (and customer interaction with such services), the data may be inherently structured, organized, or otherwise have known interrelationships. Techniques supported by the server 210 may leverage the structure in a model (e.g., machine learning model, natural language processing model, etc.) to support various AI services.

The server 210 may be configured to access and parse various types of tenant data for ingestion and model pre-training (e.g., unsupervised domain-specific pre-training). The data may include various entities that are defined by entity schema, such as entity schemas 205-a and 205-b. An entity schema may correspond to a data structure that is used to represent an entity or collection of entities (e.g., an object). In some examples, entity schemas may be data tables of a relational database system (or another type of data storage system that includes data tables). Each data table may correspond to a particular entity or object type, each row may correspond to an instance of the entity, and each column may correspond to an attribute that is captured in values across each instance of the entity. However, it should be understood that the techniques described herein may be applicable to other types of entity schemas defined by non-relational database systems (e.g., NoSQL databases), data lakes, cloud-based storage, etc., that include attributes and attribute values (e.g., fields and field values).

As illustrated in FIG. 2, the data entity schema 205-a defines a set of entities of type A, each with a set of attributes and values corresponding to the attributes. For example, entity A 215 includes a value 220-a for attribute A and a value 220-b for attribute B. As described herein, the attribute may be the column name, field name, or key corresponding to a key-value pair. The attribute name, column name, field name, or key may also be an example of or used as the basis for an attribute type identifier, as described further herein. The server 210 or an associated system or service may be configured to parse and normalize the data for model training.

The server 210 may access or receive the corpus of data (e.g., parsed or normalized training data) that includes the entity schemas 205 corresponding to the tenant. It should be understood that the corpus may include any number of entity schemas 205. For each attribute for a set of entities corresponding to an entity schema, an attribute type identifier may be identified. For example, for entities 215-a and 215-b, attribute type identifiers may be identified for attribute A and attribute B. In some cases, the attribute type identifier is the field name, column name, etc. or a control code, which may signify the attribute type. Example attribute type identifiers include “Subject,” “Description,” “Article_Title,” and “Agent_Utterance.” For each attribute corresponding to an entity (e.g., entity 215-a), the model may generate an attribute embedding based on the respective attribute type identifier and attribute value for the attribute. For example, for entity 215-a, the system may generate an attribute A embedding 225-a based on the attribute A attribute type identifier and the attribute A value 220-a. In some cases, the attribute type identifier and the attribute value are concatenated to generate the attribute embedding. For example, if the attribute type identifier is “Subject” and the attribute value is “Password reset,” then the server 210 may concatenate the text resulting in “subject: password reset” that is input into the model for attribute embedding generation. As described in further detail herein, the attribute embeddings may be generated using a transformer encoder model.

The attribute embedding process may result in an attribute embedding for each attribute of an entity. For example, the attribute embedding process results in attribute A embedding 225-a and attribute B embedding 225-b for entity 215-a. In some cases, the attribute embeddings are fixed length embeddings (e.g., fixed-length vectors). The server 210 may also be configured to generate an entity embedding for each entity based on the attribute embeddings corresponding to the particular entity. For example, for entity 215-a, the attribute A embedding 225-a and the attribute B embedding 225-b are input into an attribute aggregator function that outputs entity embedding 230. In some cases, the attribute aggregator function may be an example of an attention layer, as described in further detail herein. This entity embedding process may be performed for each entity of the entity schemas (e.g., entity schema 205-a, entity schema 205-b, etc.) resulting in a pre-trained model 240. The model 240 may include a set of formulas, parameters, and weights associated with the parameters that can be later used to predict an output (e.g., an appropriate response) to an input (e.g., a customer question via a chat bot). AI applications 245 or services, such as recommendation services or agent assistants, search services, input and reply recommendation services, intent identification services among other services (accessible by users 450) may be configured to use the mode 240. In some cases, the model may be further trained using domain or task-specific inputs in order to support more targeted AI services. Using these techniques, the model may be parametrized with topic characteristics and structural characteristics for each entity and entity type.

The trained model may use be configured with decoder aspects, which may be an example of a conditional language model. The decoder may receive an entity embedding and an attribute type identifier (e.g., attribute control code) as input and output unstructured text. The unstructured text may correspond to a value for the attribute type identifier that was received as input.

The model is described herein with reference to a transformer and similar techniques. However, it should be understood that other types of natural language encoders or other autoencoders may be used within the context of the present disclosure. For example, the data configuration for pre-training technique described herein may be used with the Word2vec or GloVe models.

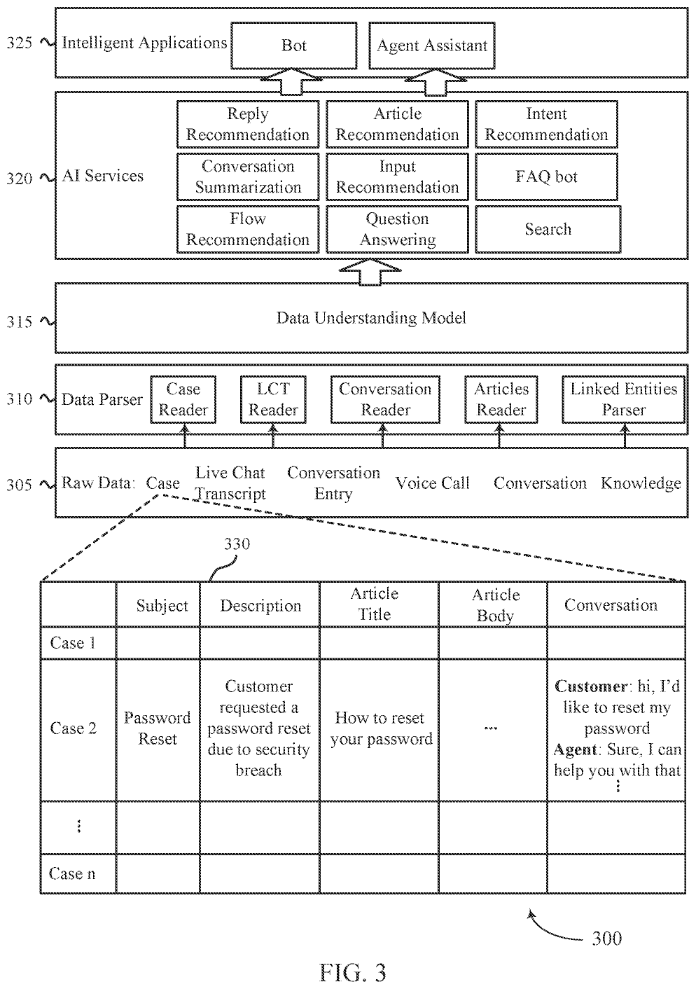

FIG. 3 illustrates an example of a diagram 300 that illustrates training a machine learning model using structured data in accordance with aspects of the present disclosure. The diagram 300 includes various components and systems that may support and may leverage aspects of the present disclosure. The various components may be implemented or supported by the server 210 of FIG. 2, the cloud platform 115 of FIG. 1, and/or the data center 120 of FIG. 1. The diagram includes raw data 305, a data parser 310, a data understanding model 315 (e.g., a pre-trained data model), AI services 320, and intelligent applications 325. Raw data 305 represents various types of tenant data associated with a particular tenant of a multitenant system. As described herein, the raw data 305 may correspond to various interactions with customers of a tenant, as well as other systems and services. The raw data 305 includes, but is not limited to, case data, live transcript data, conversation entry data, voice call data, conversation data, and knowledge. The raw data 305 may include various entity schemas (e.g., data tables), as described with respect to FIG. 2, that may represent and describe sets of entities and corresponding attributes. The raw data 305 may represent textual data and/or other types of data. For example, the voice call data may include data files including audio data of customer services calls, or the voice call data may be converted into raw text.

The data parser 310 may include various parsing processes or components that are configured to parse and normalize the data for ingestion by the model, as described herein. In some cases, the data parser 310 may be configured to convert data into raw text data. In the case that the voice call data of the raw data 305 includes audio files, the data parser 310 may be configured to convert the audio data into raw text.

The data understanding model 315 may represent the model and the data configuration as described herein, such as the process described with respect to FIG. 2. More particularly, the data understanding model 315 may represent an unsupervised domain-specific pre-trained model that is pre-trained using the techniques described herein. Thus, the parsed data output by the data parser 310 may be converted into token embeddings, attribute embeddings, and entity embeddings. Using these techniques, the model encodes as much information as possible across a tenant, and uses the information to improve existing AI services and support new AI capabilities. For example, when the model is used (e.g., a conditional language model is executed), the prediction may be at least partially informed by all of the tenant data that is ingested by the model. Using these techniques, the model may understand the relationship between each entity and each piece of knowledge stored in the database (e.g., raw data 305). As such, the various AI services 320 and application layer intelligent applications 325 may be supported by the data understanding model 315. In some cases, instances of the data understanding model 315 may be further trained using domain-specific or task-specific information to support more accurate services and applications.

The data understanding model 315 may be an example of a deep learning model or unsupervised domain-specific model pre-training where the domain is structured data (e.g., CRM data), which may be analogized to an unsupervised language model pre-training where the domain is natural language. For example, the model may be analogized to a BERT model, which may be an example technique for unsupervised domain-specific pre-training that supports training a model that learns as much as possible from some large (unlabeled) dataset related to the natural language domain in such a way that allows the model to be fine-tuned on a wide range of potentially supervised tasks within the domain. In one example, the signature of the BERT may include an input that includes an ordered contiguous block of text or a pair of ordered, contiguous blocks of text and outputs one embedding corresponding to each input token and one embedding corresponding to the entire input. As a result, BERT may be appropriate for downstream tasks that are formulated to take the same type of input, and to make predictions at the entire sequence level or at the token level. To support meaningful embeddings without supervision, BERT uses implied structure in the dataset (e.g., well-formed natural language sentences and consecutive sentences from a document have meanings that follow consecutively) for a feedback signal. Thus, BERT uses transformers that are an effective architecture for modeling variable length sequences of tokens, and BERT is parameterized as a single stack of transformer blocks.

The data understanding model 315 may be configured similarly to a BERT NLP model, with some differences that leverage the structure of tenant data. For data tables of a relational database and similar storage techniques, the data tables include well-defined rows and columns, and explicit connections may exist between tables. The techniques described herein may be applicable to other entity schemas, where each entity is composed of a set of attributes, and attributes may be fields (e.g., subject, description) or concepts such as chat utterances or article snippets or text.

The signature of the data understanding model 315 may be chosen to support various downstream tasks (e.g., AI services 320), such as case classification, article recommendation, reply recommendation, question answering, case summarization, named-entity recognition, among others. Thus, the signature may include an input that includes a collection of attributes (e.g., a full or partial entity), where each attribute may include plain text or structured data, such as dates, categorical fields, etc. The signature may include an output that includes one embedding corresponding to an entity (e.g., an entire input), one embedding corresponding to each attribute, and one embedding corresponding to each token (e.g., for text attributes).

Consideration of the implied structure is one example of a differentiator of the techniques described herein from the more general domain of natural language. As the data explicitly defines structure on the relatedness between different blocks of text, the patterns in the data may more readily captured. A case table 330 illustrated in FIG. 3 may be used to demonstrate how the characteristics of the data are captured by the model. Each block of text in the table may represent an entry. Entries may be stylistically related (e.g., a structural characteristic) by the column in which they belong, and entries may be topically related (e.g., a topic characteristic) by the row in which they belong. The topic characteristic may correspond to the notion that each entry or attribute value corresponding to a particular entity is discussing, referencing, or is otherwise related to the same context or topic (e.g., the entries are contextually related). The structural characteristic may correspond to the notion that each entry for a particular attribute across the set of entities of the entity schema has a similar semantic structure (e.g., a similar number of words and structure). For example, the subject column of the data table 330 may include a limited number of words and may not have a standard well-defined sentence structure, whereas the description and conversation columns may have similar well-defined sentence structures.

In one example, this structure may be captured mathematically by combining a latent variable model of tenants with the concept of controllable text generation. This model may assume that each instance of an entity is associated with a topic (e.g., the topic characteristic or aboutness), denoted by z. The attributes of an entity are conditionally independent, given z, and all attributes, across all entities, are drawn from the same distribution (e.g., language model), conditioned on both a topic vector and an attribute control code (e.g., an attribute type identifier), signifying the attribute type (e.g., subject, description, agent utterance, etc.). Formally, the model may be captured as follows:

$$P ( E ) = \int P ( E , z ) dz = \int p ( E \vert z ) p ( z ) dz = \int {\prod }_{k = 1}^{n} {p}_{θ} ( {A}_{k} \vert z , {c}_{k} ) p ( z ) dz$$

where,
E:={A₁, . . . , Aₙ} is an entity containing attributes A₁, . . . , Aₙ,
p_{θ} is a language model parameterized by θ, and
cₖ is a discrete control code (e.g., an attribute identifier) associated with attribute k (e.g., subject, description, agent_utterance, etc.).

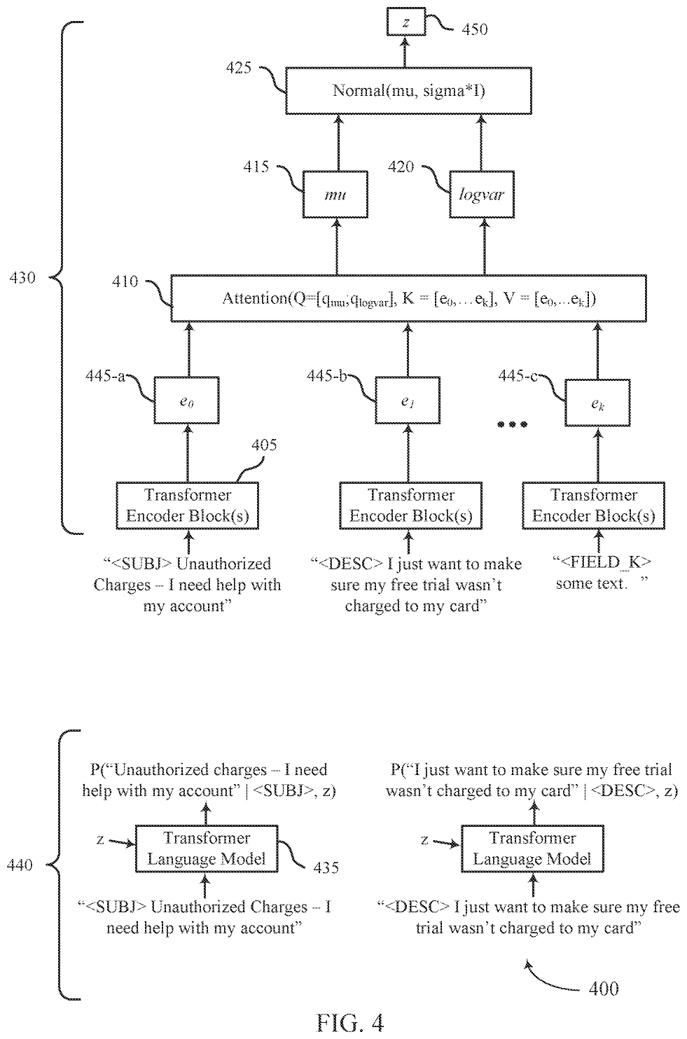

The objective associated with the data understanding model 315 may be maximum likelihood of estimation of p(E). An example architecture that may be used to capture these objectives may be illustrated in FIG. 4.

One property of the model is that the conditional language aspects (e.g., decoder aspects), as further described herein, may be defined as any proper probability distribution (rather than strictly as a language model). This supports hierarchical entity distributions. For example, a tenant may attach every live chat conversation to a case in a data store. The model may be configured such that the live chat conversation itself is an attribute for the case entity (e.g., as illustrated in table 330), and the distribution over the live chat entity may be defined in numerous ways. For example, one use case may be supported by a conversation model, which may explicitly model the conversation as a sequence of utterances, where each utterance is separately encoded as an attribute embedding (and captured in the entity embedding).

In another technique for supporting relationships between entities, primary/foreign key relationships in a database may be used as a lookup table. For example, if the data includes both an account entity and a case entity, when the model is encoding a case, the model may encounter an AccountlD field, recognize the AccountlD field as a foreign key, and use the last computed account entity embedding for the account as the attribute embedding for the case entity. Other techniques for supporting relationships between tenant data are contemplated within the scope of the present disclosure.

FIG. 4 illustrates an example of a model architecture 400 that supports training a machine learning model using structured data in accordance with aspects of the present disclosure. The model architecture 400 may be implemented or supported by the components of the diagram 300 of FIG. 2, the server 210 of FIG. 2 and/or the cloud platform 115 and data center 120 of FIG. 1 The model architecture 400 includes an encoder function 430 and a decoder function 440. Because the model architecture 400 includes an encoder function 430 and a decoder function 440, the model architecture 400 may be referred to as an encoder-decoder network. In the above model representation, by choosing p(z) to be Gaussian and optimizing p(E) by amortized variational inference, the formulation may be a variational autoencoder for a tenant.

The encoder function 430 may receive a data entity (e.g., object) as input and return a fixed-length vector (e.g., an entity embedding), as described elsewhere herein. The encoder function 430 may include two functions including an attribute encoder and an attribute aggregator. The attribute encoder may receive attribute control (e.g., an attribute type identifier) plus unstructured text (or structured text) as input (e.g., “<SUBJ> Password Reset”) and outputs a fixed-length attribute embedding. As illustrated in FIG. 4, the attribute encoder may be in the form of transformer encoder blocks 405. The transformer encoder blocks 405 may be an example of a Transformer deep learning model. The transformer encoder blocks 405 may include built-in attention mechanisms that automatically parameterizes or provides greater weight to the relevant portions of the input data. In some cases, the transformer encoder blocks 405 may be an example of a pre-trained transformer with some additional parameters that may be adjusted to account for the tenant data.

The attribute aggregator function of the encoder function 430 may be configured to receive an unordered, variable-length collection of attribute embeddings and output a fixed-length entity embedding. the attribute aggregator function may be a variational inference model. As illustrated in FIG. 4, the attribute aggregator function is represented by an attention layer function 410 that receives the attribute embeddings for each attribute (e.g., attribute embeddings 445). The attribute layer may output a sampling distribution defined by a mean 415 and variance 420, which may be sampled to generate an entity embedding 450. The encoder function 430 may be used for a set of entities corresponding to an entity schema and for other sets of entities corresponding to other entity schemas. As described, the attribute aggregator function (e.g., the attention layer function 410) and the transformer encoder blocks 405 both include attention mechanisms/functionality. As the transformer encoder blocks 405 may create embeddings of each token of an attribute value and use the attention mechanism to sample the relevant (e.g., important-related to the topic characteristic) tokens to generate attribute embeddings, and the attention layer function 410 receives and uses the attribute embeddings to generate the entity embedding 450, this technique supports capture of the topic characteristic within the tokens of an attribute as well as the topic characteristic between the attribute values of the entity as well as the structural characteristic of the attributes.

The decoder function 440 may be an example of a conditional language model that receives an entity embedding (z) (or a random sample form the prior p(z)) and an attribute control code (e.g., an attribute type identifier) as input and outputs unstructured text (e.g., a field value). The decoder may use examples transformers (e.g., transformer language model 435) to output the unstructured text. In some examples, the entity embedding (z) that is input into the decoder function 440 may be a partial entity (e.g., the entity is missing one or more attribute values). Thus, the set of existing attributes and values may be used to generate an entity embedding as described herein. The entity embedding (partial) with one or more attribute type identifiers corresponding to the missing information may be input into the decoder function 440 to generate the text or a field value corresponding to the missing attributes. Thus, the conditional language model may generate text that is topically controlled by a latent variable and stylistically controlled by the control code. This functionality may support a variety of use cases, such as autofill, response recommendation, article recommendation, etc. For example, the model may use an entity encoding of a live chat transcript and at inference time, the transcript may not be complete because the system is in the middle of a conversation. The model may support generation of a prediction or guess of the full conversation embedding based on the available utterances. The model may also be applicable to knowledge search and discovery, deep semantic search, contextual autocomplete, conversation summarization, conversational flow extraction, etc.

The components of architecture are trained according to the objectives described with respect to FIG. 3, resulting in the entity encoder (e.g., attention layer 425), attribute encoder (e.g., transformer encoder blocks 405), and conditional language model (e.g., decoder function 440), each of which may contain an understanding of the structure present in the tenant data. The structure includes the repetitiveness of such data. For example, data for an e-commerce customer support chat service may contain hundreds or thousands of similar or the same conversation where a customer is asking for the shipping status of the item that the customer ordered. Similar sets of conversations may relate to password reset, account information, etc. Thus, the nature of such data that may include repetitiveness over a narrow range of topics may support the efficacy of the modeling approach described herein.

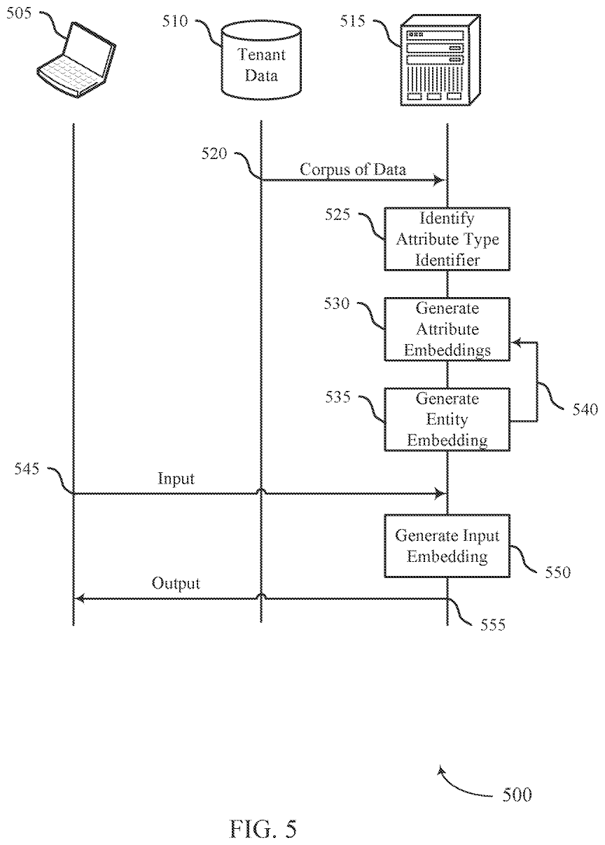

FIG. 5 illustrates an example of a process flow diagram 500 that illustrates training a machine learning model using structured data in accordance with aspects of the present disclosure. The process flow diagram 500 includes a user device 505, a tenant data store 510, and a server 515. The user device 505 may be an example of a device of a cloud client 110 or contact 105 of FIG. 1. The tenant data store 510 may represent a corpus of data associated with a tenant of a multi-tenant system and may be supported by various aspects of FIGS. 1 through 5, including the data center 120 of FIG. 1. The server 515 may be an example of the server 210 of FIG. 2 and may implement various components of the diagram 300 of FIG. 3 and/or the model architecture 400 of FIG. 4.

At 520, the server may receive, from the tenant data store 510, a corpus of training data including a plurality of data entity schemas. Each data entity schema may define a respective set of attributes for a respective set of data entities corresponding to each data entity schema. A first data entity of a first set of data entities corresponding to a first data entity schema may be associated with a topic characteristic based on a first set of attributes defined by the first data entity schema, and a first attribute of the first set of attributes may be associated with a structural characteristic that is common across each of the first set of data entities. The data entity schema may be an example of a data table of a relational database system, where each row of the data table corresponds to a data entity.

At 525, the server 515 may identify for each attribute of the first set of attributes, a respective attribute type identifier. In some cases, the attribute type identifier may be identified based on an attribute name or column name of a data table, a field name, or the like.

At 530, the server 515 may generate for each attribute of the first set of attributes corresponding to the first data entity, an attribute embedding based on the respective attribute type identifier and an attribute value for each attribute. In some cases, the attribute type identifier and the corresponding attribute value for the data entity may be concatenated for an input into the data model. The attribute embedding may be generated using a transformer based model (e.g., transformer encoding blocks).

At 535, the server 515 may generate an entity embedding based on the attribute embedding for each attribute of the first set of attributes associated with the first data entity. The entity embedding may be generated using an attention layer that receives the attribute embeddings as inputs. The attention layer may generate a sampling distribution defined by a mean and a variance. The sampling distribution may be sampled to generate the entity embedding for the entity.

At 540, the server 515 may parameterize the topic characteristic for each data entity of the first set of data entities and the structural characteristic for each attribute of the first set of attributes in the machine learning model by generating the attribute embedding and the entity embedding for each data entity of the first set of data entities. More particularly, the attribute embedding and entity embedding process may be repeated for the set of entities for the entity schema as well as for other entity schemas of the tenant data, thereby encoding understandings of the tenant data into the model.

At 545, the server 515 may receive, from the user device 505 (or from some other data source supporting the user device or another system), an input that corresponds to a data entity and an indication of an attribute type identifier. The indication of the attribute type identifier may be selected by a user, generated by a client application (e.g., an attribute type identifier corresponding to some missing information), etc. The input may include one or more attribute values that may correspond to an entity. At 550, the server 515 may generate an input embedding based at least in part on the input. For example, the model may generate an embedding based on the attribute values. At 555, the server may generate and transmit an output that includes a predicted value corresponding to the attribute type identifier. Thus, the model may function as a conditional language model.

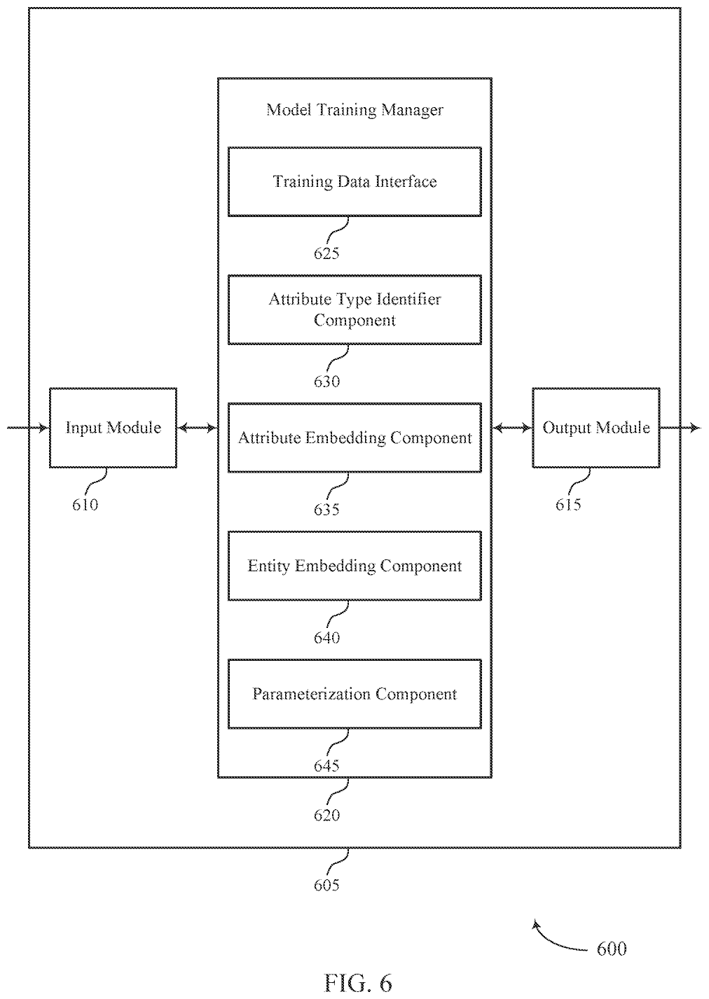

FIG. 6 shows a block diagram 600 of a device 605 that supports training a machine learning model using structured data in accordance with aspects of the present disclosure. The device 605 may include an input module 610, an output module 615, and a model training manager 620. The device 605 may also include a processor. Each of these components may be in communication with one another (e.g., via one or more buses).

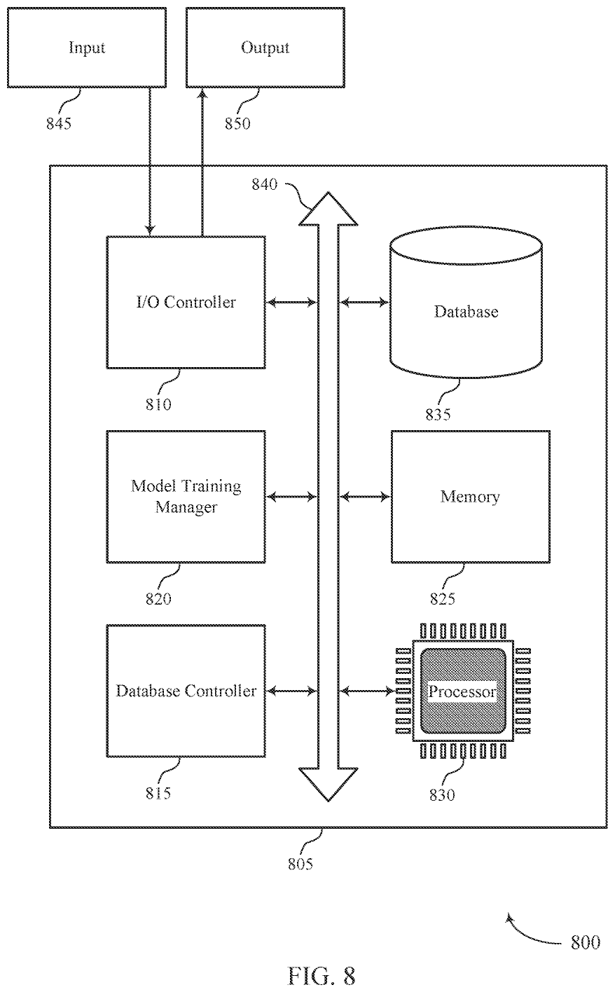

The input module 610 may manage input signals for the device 605. For example, the input module 610 may identify input signals based on an interaction with a modem, a keyboard, a mouse, a touchscreen, or a similar device. These input signals may be associated with user input or processing at other components or devices. In some cases, the input module 610 may utilize an operating system such as iOS®, ANDROID®, MS-DOS®, MS-WINDOWS®, OS/2®, UNIX®, LINUX®, or another known operating system to handle input signals. The input module 610 may send aspects of these input signals to other components of the device 605 for processing. For example, the input module 610 may transmit input signals to the model training manager 620 to support training a machine learning model using structured data. In some cases, the input module 610 may be a component of an I/O controller 810 as described with reference to FIG. 8.

The output module 615 may manage output signals for the device 605. For example, the output module 615 may receive signals from other components of the device 605, such as the model training manager 620, and may transmit these signals to other components or devices. In some specific examples, the output module 615 may transmit output signals for display in a user interface, for storage in a database or data store, for further processing at a server or server cluster, or for any other processes at any number of devices or systems. In some cases, the output module 615 may be a component of an I/O controller 810 as described with reference to FIG. 8.

For example, the model training manager 620 may include a training data interface 625, an attribute type identifier component 630, an attribute embedding component 635, an entity embedding component 640, a parameterization component 645, or any combination thereof. In some examples, the model training manager 620, or various components thereof, may be configured to perform various operations (e.g., receiving, monitoring, transmitting) using or otherwise in cooperation with the input module 610, the output module 615, or both. For example, the model training manager 620 may receive information from the input module 610, send information to the output module 615, or be integrated in combination with the input module 610, the output module 615, or both to receive information, transmit information, or perform various other operations as described herein.

The model training manager 620 may support training a machine learning model in accordance with examples as disclosed herein. The training data interface 625 may be configured as or otherwise support a means for receiving a corpus of training data including a plurality of data entity schemas, wherein each data entity schema defines a respective set of attributes for a respective set of data entities corresponding to each data entity schema, wherein a first data entity of a first set of data entities corresponding to a first data entity schema is associated with a topic characteristic based on a first set of attributes defined by the first data entity schema, and wherein a first attribute of the first set of attributes is associated with a structural characteristic that is common across each of the first set of data entities. The attribute type identifier component 630 may be configured as or otherwise support a means for identifying, for each attribute of the first set of attributes, a respective attribute type identifier. The attribute embedding component 635 may be configured as or otherwise support a means for generating, for each attribute of the first set of attributes corresponding to the first data entity, an attribute embedding based on the respective attribute type identifier and an attribute value for each attribute. The entity embedding component 640 may be configured as or otherwise support a means for generating an entity embedding based on the attribute embedding for each attribute of the first set of attributes associated with the first data entity. The parameterization component 645 may be configured as or otherwise support a means for parameterizing the topic characteristic for each data entity of the first set of data entities and the structural characteristic for each attribute of the first set of attributes in the machine learning model by generating the attribute embedding and the entity embedding for each data entity of the first set of data entities.

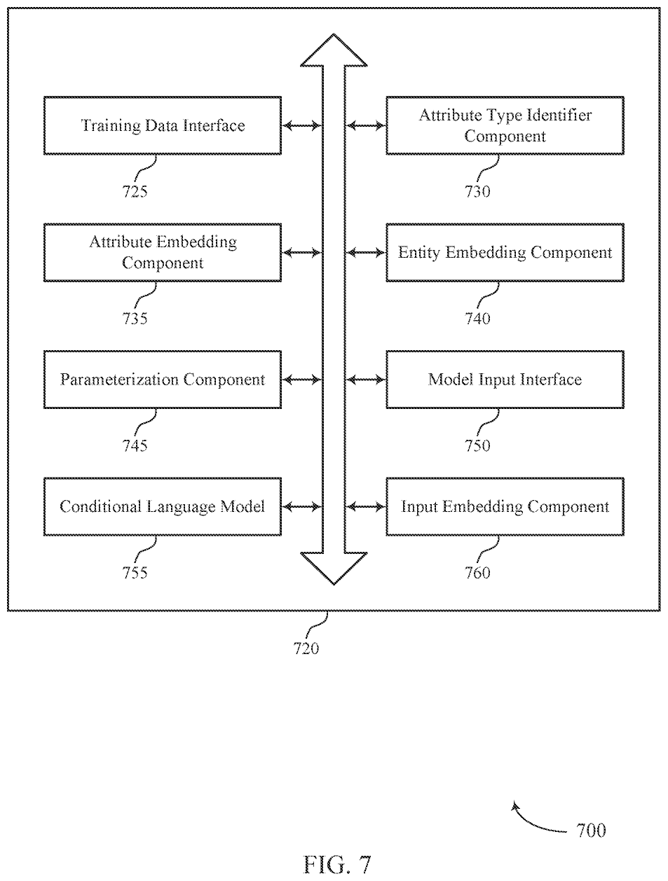

FIG. 7 shows a block diagram 700 of a model training manager 720 that supports training a machine learning model using structured data in accordance with aspects of the present disclosure. The model training manager 720 may be an example of aspects of a model training manager or a model training manager 620, or both, as described herein. The model training manager 720, or various components thereof, may be an example of means for performing various aspects of training a machine learning model using structured data as described herein. For example, the model training manager 720 may include a training data interface 725, an attribute type identifier component 730, an attribute embedding component 735, an entity embedding component 740, a parameterization component 745, a model input interface 750, a conditional language model 755, an input embedding component 760, or any combination thereof. Each of these components may communicate, directly or indirectly, with one another (e.g., via one or more buses).

The model training manager 720 may support training a machine learning model in accordance with examples as disclosed herein. The training data interface 725 may be configured as or otherwise support a means for receiving a corpus of training data including a plurality of data entity schemas, wherein each data entity schema defines a respective set of attributes for a respective set of data entities corresponding to each data entity schema, wherein a first data entity of a first set of data entities corresponding to a first data entity schema is associated with a topic characteristic based on a first set of attributes defined by the first data entity schema, and wherein a first attribute of the first set of attributes is associated with a structural characteristic that is common across each of the first set of data entities. The attribute type identifier component 730 may be configured as or otherwise support a means for identifying, for each attribute of the first set of attributes, a respective attribute type identifier. The attribute embedding component 735 may be configured as or otherwise support a means for generating, for each attribute of the first set of attributes corresponding to the first data entity, an attribute embedding based on the respective attribute type identifier and an attribute value for each attribute. The entity embedding component 740 may be configured as or otherwise support a means for generating an entity embedding based on the attribute embedding for each attribute of the first set of attributes associated with the first data entity. The parameterization component 745 may be configured as or otherwise support a means for parameterizing the topic characteristic for each data entity of the first set of data entities and the structural characteristic for each attribute of the first set of attributes in the machine learning model by generating the attribute embedding and the entity embedding for each data entity of the first set of data entities.

In some examples, the model input interface 750 may be configured as or otherwise support a means for receiving an input that corresponds to a data entity and an indication of an attribute type identifier. In some examples, the conditional language model 755 may be configured as or otherwise support a means for generating, by the machine learning model, an output that includes a value corresponding to the attribute type identifier based at least in part on the input.

In some examples, the input embedding component 760 may be configured as or otherwise support a means for generating, by the machine learning model, an input embedding based at least in part on the input, wherein the output is generated based at least in part on the input embedding and the indication of the attribute type identifier.

In some examples, to support identifying the respective attribute type identifier, the attribute type identifier component 730 may be configured as or otherwise support a means for identifying, for each attribute, a column name of a column associated with each attribute in a data table corresponding to the first data entity schema. In some examples, to support identifying the respective attribute type identifier, the attribute type identifier component 730 may be configured as or otherwise support a means for generating the respective attribute type identifier based on the column name of the column, wherein each row of the data table corresponds to a respective data entity of the first set of data entities.

In some examples, the entity embedding component 740 may be configured as or otherwise support a means for using a transformer based machine learning model to generate the attribute embedding and the entity embedding.

In some examples, to support generating the entity embedding, the entity embedding component 740 may be configured as or otherwise support a means for generating a sampling distribution using an attention layer that receives the attribute embedding for each attribute of the first set of attributes as input. In some examples, to support generating the entity embedding, the entity embedding component 740 may be configured as or otherwise support a means for sampling the sampling distribution to generate the entity embedding.

In some examples, the attribute embedding component 735 may be configured as or otherwise support a means for concatenating the respective attribute type identifier and the attribute value for each attribute, wherein the attribute embedding is generated based on the concatenated respective attribute type identifier and the attribute value.

In some examples, the attribute embedding component 735 may be configured as or otherwise support a means for generating, for each token of an attribute value for a first attribute, a token embedding, wherein the attribute embedding for the attribute value is generated based at least in part on each token embedding for the attribute value.

In some examples, the attribute embedding component 735 may be configured as or otherwise support a means for identifying that an attribute value for a second attribute references a second data entity of a second data entity schema of the plurality of data entity schemas. In some examples, the attribute embedding component 735 may be configured as or otherwise support a means for using, for the attribute embedding for the second attribute, the entity embedding that is generated for the second data entity, wherein the entity embedding for the first data entity is generated based at least in part on the entity embedding for the second data entity.

In some examples, the attribute embedding component 735 may be configured as or otherwise support a means for identifying that the attribute value for a second attribute references set of related attribute values. In some examples, the attribute embedding component 735 may be configured as or otherwise support a means for generating the attribute embedding for each related attribute value of the set of related attribute values, wherein each of the attribute embeddings for each related attribute value is based on the identified attribute type identifier and the entity embedding is generated based on the each of the attribute embeddings for each related attribute value.

FIG. 8 shows a diagram of a system 800 including a device 805 that supports training a machine learning model using structured data in accordance with aspects of the present disclosure. The device 805 may be an example of or include the components of a device 605 as described herein. The device 805 may include components for bi-directional data communications including components for transmitting and receiving communications, such as a model training manager 820, an I/O controller 810, a database controller 815, a memory 825, a processor 830, and a database 835. These components may be in electronic communication or otherwise coupled (e.g., operatively, communicatively, functionally, electronically, electrically) via one or more buses (e.g., a bus 840).

The I/O controller 810 may manage input signals 845 and output signals 850 for the device 805. The I/O controller 810 may also manage peripherals not integrated into the device 805. In some cases, the I/O controller 810 may represent a physical connection or port to an external peripheral. In some cases, the I/O controller 810 may utilize an operating system such as iOS®, ANDROID®, MS-DOS®, MS-WINDOWS®, OS/2®, UNIX®, LINUX®, or another known operating system. In other cases, the I/O controller 810 may represent or interact with a modem, a keyboard, a mouse, a touchscreen, or a similar device. In some cases, the I/O controller 810 may be implemented as part of a processor. In some cases, a user may interact with the device 805 via the I/O controller 810 or via hardware components controlled by the I/O controller 810.

The database controller 815 may manage data storage and processing in a database 835. In some cases, a user may interact with the database controller 815. In other cases, the database controller 815 may operate automatically without user interaction. The database 835 may be an example of a single database, a distributed database, multiple distributed databases, a data store, a data lake, or an emergency backup database.

Memory 825 may include random-access memory (RAM) and ROM. The memory 825 may store computer-readable, computer-executable software including instructions that, when executed, cause the processor to perform various functions described herein. In some cases, the memory 825 may contain, among other things, a basic input/output system (BIOS) which may control basic hardware or software operation such as the interaction with peripheral components or devices.

The processor 830 may include an intelligent hardware device, (e.g., a general-purpose processor, a digital signal processor (DSP), a CPU, a microcontroller, an ASIC, an field programmable gate array (FPGA), a programmable logic device, a discrete gate or transistor logic component, a discrete hardware component, or any combination thereof). In some cases, the processor 830 may be configured to operate a memory array using a memory controller. In other cases, a memory controller may be integrated into the processor 830. The processor 830 may be configured to execute computer-readable instructions stored in a memory 825 to perform various functions (e.g., functions or tasks supporting training a machine learning model using structured data).

The model training manager 820 may support training a machine learning model in accordance with examples as disclosed herein. For example, the model training manager 820 may be configured as or otherwise support a means for receiving a corpus of training data including a plurality of data entity schemas, wherein each data entity schema defines a respective set of attributes for a respective set of data entities corresponding to each data entity schema, wherein a first data entity of a first set of data entities corresponding to a first data entity schema is associated with a topic characteristic based on a first set of attributes defined by the first data entity schema, and wherein a first attribute of the first set of attributes is associated with a structural characteristic that is common across each of the first set of data entities. The model training manager 820 may be configured as or otherwise support a means for identifying, for each attribute of the first set of attributes, a respective attribute type identifier. The model training manager 820 may be configured as or otherwise support a means for generating, for each attribute of the first set of attributes corresponding to the first data entity, an attribute embedding based on the respective attribute type identifier and an attribute value for each attribute. The model training manager 820 may be configured as or otherwise support a means for generating an entity embedding based on the attribute embedding for each attribute of the first set of attributes associated with the first data entity. The model training manager 820 may be configured as or otherwise support a means for parameterizing the topic characteristic for each data entity of the first set of data entities and the structural characteristic for each attribute of the first set of attributes in the machine learning model by generating the attribute embedding and the entity embedding for each data entity of the first set of data entities.

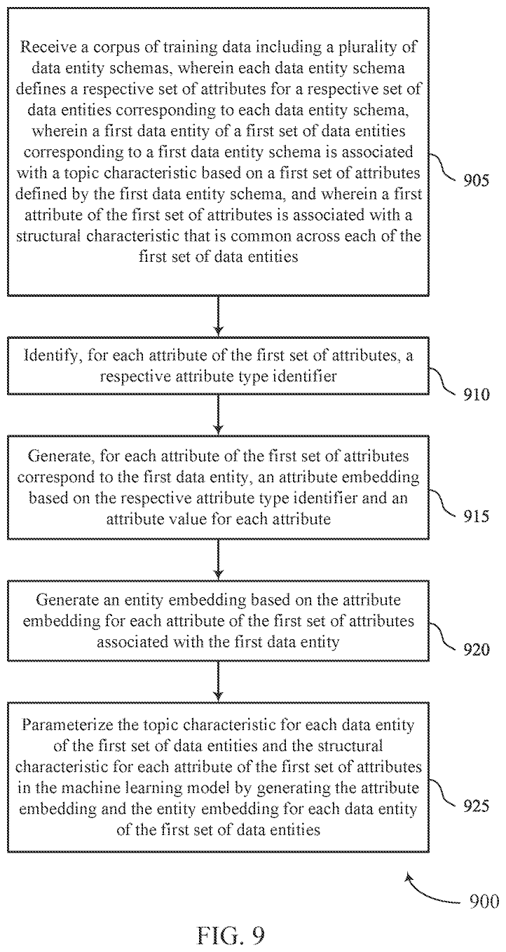

FIG. 9 shows a flowchart illustrating a method 900 that supports training a machine learning model using structured data in accordance with aspects of the present disclosure. The operations of the method 900 may be implemented by a database server or application server or its components as described herein. For example, the operations of the method 900 may be performed by a database server or application server as described with reference to FIGS. 1 through 8. In some examples, a database server or application server may execute a set of instructions to control the functional elements of the database server or application server to perform the described functions. Additionally or alternatively, the database server or application server may perform aspects of the described functions using special-purpose hardware.

At 905, the method may include receiving a corpus of training data including a plurality of data entity schemas, wherein each data entity schema defines a respective set of attributes for a respective set of data entities corresponding to each data entity schema, wherein a first data entity of a first set of data entities corresponding to a first data entity schema is associated with a topic characteristic based on a first set of attributes defined by the first data entity schema, and wherein a first attribute of the first set of attributes is associated with a structural characteristic that is common across each of the first set of data entities. The operations of 905 may be performed in accordance with examples as disclosed herein. In some examples, aspects of the operations of 905 may be performed by a training data interface 725 as described with reference to FIG. 7.

At 910, the method may include identifying, for each attribute of the first set of attributes, a respective attribute type identifier. The operations of 910 may be performed in accordance with examples as disclosed herein. In some examples, aspects of the operations of 910 may be performed by an attribute type identifier component 730 as described with reference to FIG. 7.

At 915, the method may include generating, for each attribute of the first set of attributes corresponding to the first data entity, an attribute embedding based on the respective attribute type identifier and an attribute value for each attribute. The operations of 915 may be performed in accordance with examples as disclosed herein. In some examples, aspects of the operations of 915 may be performed by an attribute embedding component 735 as described with reference to FIG. 7.

At 920, the method may include generating an entity embedding based on the attribute embedding for each attribute of the first set of attributes associated with the first data entity. The operations of 920 may be performed in accordance with examples as disclosed herein. In some examples, aspects of the operations of 920 may be performed by an entity embedding component 740 as described with reference to FIG. 7.

At 925, the method may include parameterizing the topic characteristic for each data entity of the first set of data entities and the structural characteristic for each attribute of the first set of attributes in the machine learning model by generating the attribute embedding and the entity embedding for each data entity of the first set of data entities. The operations of 925 may be performed in accordance with examples as disclosed herein. In some examples, aspects of the operations of 925 may be performed by a parameterization component 745 as described with reference to FIG. 7.

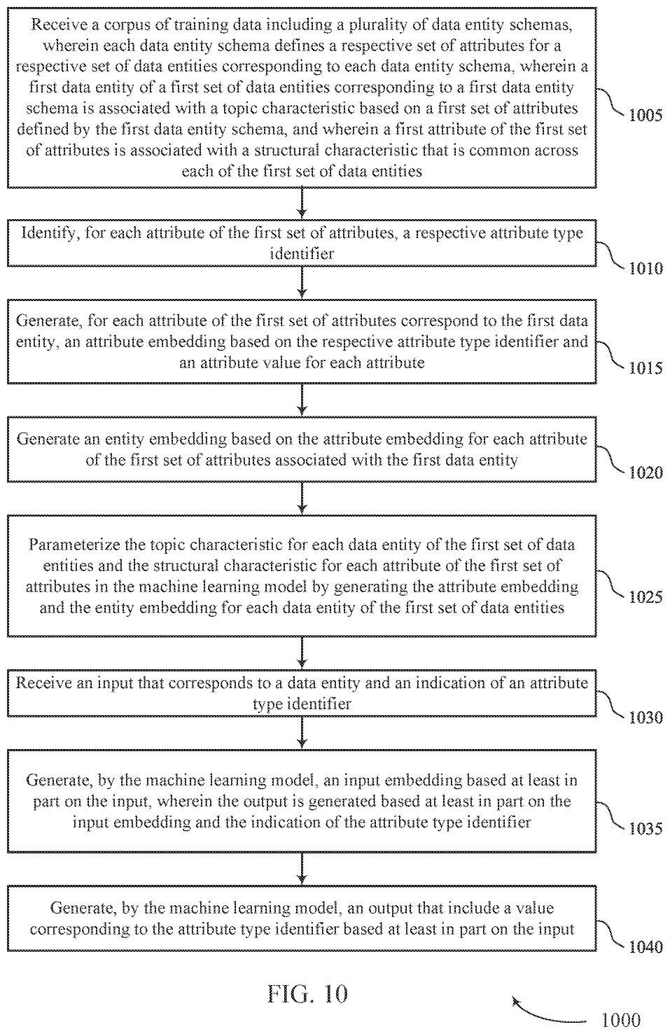

FIG. 10 shows a flowchart illustrating a method 1000 that supports training a machine learning model using structured data in accordance with aspects of the present disclosure. The operations of the method 1000 may be implemented by a database server or application server or its components as described herein. For example, the operations of the method 1000 may be performed by a database server or application server as described with reference to FIGS. 1 through 8 through 8. In some examples, a database server or application server may execute a set of instructions to control the functional elements of the database server or application server to perform the described functions. Additionally or alternatively, the database server or application server may perform aspects of the described functions using special-purpose hardware.

At 1005, the method may include receiving a corpus of training data including a plurality of data entity schemas, wherein each data entity schema defines a respective set of attributes for a respective set of data entities corresponding to each data entity schema, wherein a first data entity of a first set of data entities corresponding to a first data entity schema is associated with a topic characteristic based on a first set of attributes defined by the first data entity schema, and wherein a first attribute of the first set of attributes is associated with a structural characteristic that is common across each of the first set of data entities. The operations of 1005 may be performed in accordance with examples as disclosed herein. In some examples, aspects of the operations of 1005 may be performed by a training data interface 725 as described with reference to FIG. 7.

At 1010, the method may include identifying, for each attribute of the first set of attributes, a respective attribute type identifier. The operations of 1010 may be performed in accordance with examples as disclosed herein. In some examples, aspects of the operations of 1010 may be performed by an attribute type identifier component 730 as described with reference to FIG. 7.

At 1015, the method may include generating, for each attribute of the first set of attributes corresponding to the first data entity, an attribute embedding based on the respective attribute type identifier and an attribute value for each attribute. The operations of 1015 may be performed in accordance with examples as disclosed herein. In some examples, aspects of the operations of 1015 may be performed by an attribute embedding component 735 as described with reference to FIG. 7.

At 1020, the method may include generating an entity embedding based on the attribute embedding for each attribute of the first set of attributes associated with the first data entity. The operations of 1020 may be performed in accordance with examples as disclosed herein. In some examples, aspects of the operations of 1020 may be performed by an entity embedding component 740 as described with reference to FIG. 7.

At 1025, the method may include parameterizing the topic characteristic for each data entity of the first set of data entities and the structural characteristic for each attribute of the first set of attributes in the machine learning model by generating the attribute embedding and the entity embedding for each data entity of the first set of data entities. The operations of 1025 may be performed in accordance with examples as disclosed herein. In some examples, aspects of the operations of 1025 may be performed by a parameterization component 745 as described with reference to FIG. 7.

At 1030, the method may include receiving an input that corresponds to a data entity and an indication of an attribute type identifier. The operations of 1030 may be performed in accordance with examples as disclosed herein. In some examples, aspects of the operations of 1030 may be performed by a model input interface 750 as described with reference to FIG. 7.

At 1035, the method may include generating, by the machine learning model, an input embedding based at least in part on the input, wherein the output is generated based at least in part on the input embedding and the indication of the attribute type identifier. The operations of 1035 may be performed in accordance with examples as disclosed herein. In some examples, aspects of the operations of 1035 may be performed by an input embedding component 760 as described with reference to FIG. 7.

At 1040, the method may include generating, by the machine learning model, an output that includes a value corresponding to the attribute type identifier based at least in part on the input. The operations of 1040 may be performed in accordance with examples as disclosed herein. In some examples, aspects of the operations of 1040 may be performed by a conditional language model 755 as described with reference to FIG. 7.

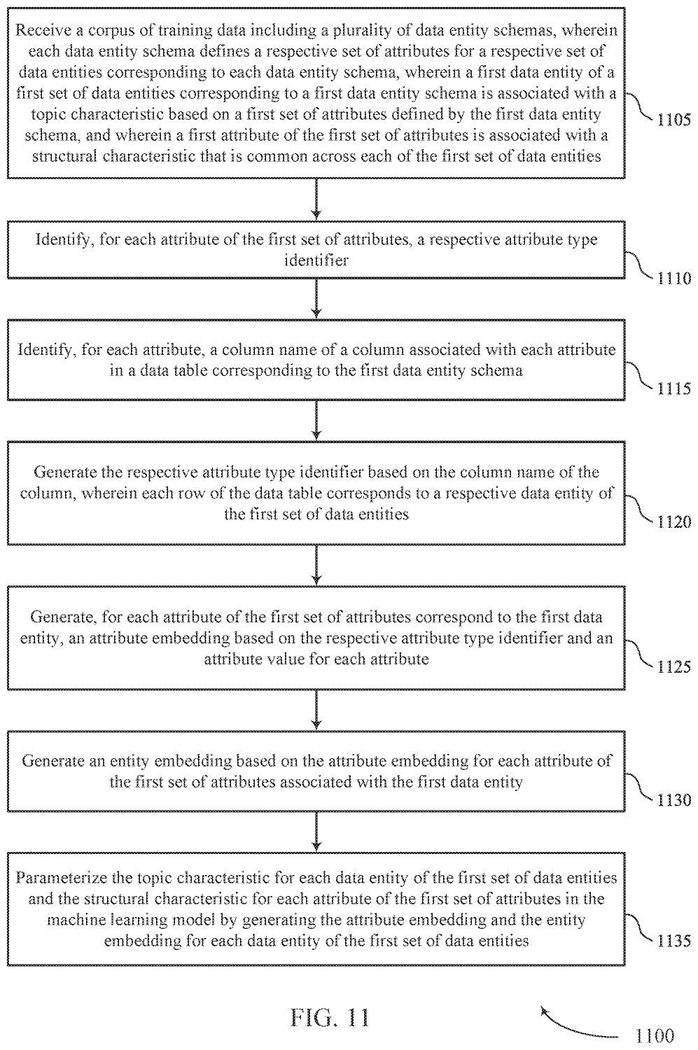

FIG. 11 shows a flowchart illustrating a method 1100 that supports training a machine learning model using structured data in accordance with aspects of the present disclosure. The operations of the method 1100 may be implemented by a database server or application server or its components as described herein. For example, the operations of the method 1100 may be performed by a database server or application server as described with reference to FIGS. 1 through 8 through 8. In some examples, a database server or application server may execute a set of instructions to control the functional elements of the database server or application server to perform the described functions. Additionally or alternatively, the database server or application server may perform aspects of the described functions using special-purpose hardware.

At 1105, the method may include receiving a corpus of training data including a plurality of data entity schemas, wherein each data entity schema defines a respective set of attributes for a respective set of data entities corresponding to each data entity schema, wherein a first data entity of a first set of data entities corresponding to a first data entity schema is associated with a topic characteristic based on a first set of attributes defined by the first data entity schema, and wherein a first attribute of the first set of attributes is associated with a structural characteristic that is common across each of the first set of data entities. The operations of 1105 may be performed in accordance with examples as disclosed herein. In some examples, aspects of the operations of 1105 may be performed by a training data interface 725 as described with reference to FIG. 7.

At 1110, the method may include identifying, for each attribute of the first set of attributes, a respective attribute type identifier. The operations of 1110 may be performed in accordance with examples as disclosed herein. In some examples, aspects of the operations of 1110 may be performed by an attribute type identifier component 730 as described with reference to FIG. 7.

At 1115, the method may include identifying, for each attribute, a column name of a column associated with each attribute in a data table corresponding to the first data entity schema. The operations of 1115 may be performed in accordance with examples as disclosed herein. In some examples, aspects of the operations of 1115 may be performed by an attribute type identifier component 730 as described with reference to FIG. 7.

At 1120, the method may include generating the respective attribute type identifier based on the column name of the column, wherein each row of the data table corresponds to a respective data entity of the first set of data entities. The operations of 1120 may be performed in accordance with examples as disclosed herein. In some examples, aspects of the operations of 1120 may be performed by an attribute type identifier component 730 as described with reference to FIG. 7.

At 1125, the method may include generating, for each attribute of the first set of attributes corresponding to the first data entity, an attribute embedding based on the respective attribute type identifier and an attribute value for each attribute. The operations of 1125 may be performed in accordance with examples as disclosed herein. In some examples, aspects of the operations of 1125 may be performed by an attribute embedding component 735 as described with reference to FIG. 7.

At 1130, the method may include generating an entity embedding based on the attribute embedding for each attribute of the first set of attributes associated with the first data entity. The operations of 1130 may be performed in accordance with examples as disclosed herein. In some examples, aspects of the operations of 1130 may be performed by an entity embedding component 740 as described with reference to FIG. 7.

At 1135, the method may include parameterizing the topic characteristic for each data entity of the first set of data entities and the structural characteristic for each attribute of the first set of attributes in the machine learning model by generating the attribute embedding and the entity embedding for each data entity of the first set of data entities. The operations of 1135 may be performed in accordance with examples as disclosed herein. In some examples, aspects of the operations of 1135 may be performed by a parameterization component 745 as described with reference to FIG. 7.

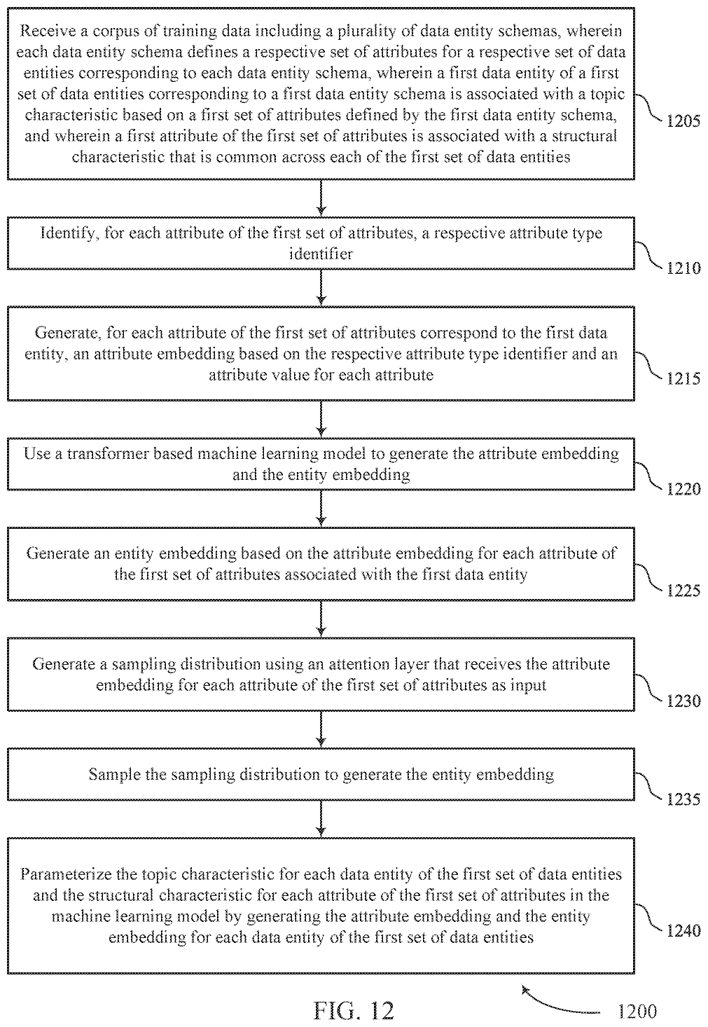

FIG. 12 shows a flowchart illustrating a method 1200 that supports training a machine learning model using structured data in accordance with aspects of the present disclosure. The operations of the method 1200 may be implemented by a database server or application server or its components as described herein. For example, the operations of the method 1200 may be performed by a database server or application server as described with reference to FIGS. 1 through 8. In some examples, a database server or application server may execute a set of instructions to control the functional elements of the database server or application server to perform the described functions. Additionally or alternatively, the database server or application server may perform aspects of the described functions using special-purpose hardware.

At 1205, the method may include receiving a corpus of training data including a plurality of data entity schemas, wherein each data entity schema defines a respective set of attributes for a respective set of data entities corresponding to each data entity schema, wherein a first data entity of a first set of data entities corresponding to a first data entity schema is associated with a topic characteristic based on a first set of attributes defined by the first data entity schema, and wherein a first attribute of the first set of attributes is associated with a structural characteristic that is common across each of the first set of data entities. The operations of 1205 may be performed in accordance with examples as disclosed herein. In some examples, aspects of the operations of 1205 may be performed by a training data interface 725 as described with reference to FIG. 7.

At 1210, the method may include identifying, for each attribute of the first set of attributes, a respective attribute type identifier. The operations of 1210 may be performed in accordance with examples as disclosed herein. In some examples, aspects of the operations of 1210 may be performed by an attribute type identifier component 730 as described with reference to FIG. 7.

At 1215, the method may include generating, for each attribute of the first set of attributes corresponding to the first data entity, an attribute embedding based on the respective attribute type identifier and an attribute value for each attribute. The operations of 1215 may be performed in accordance with examples as disclosed herein. In some examples, aspects of the operations of 1215 may be performed by an attribute embedding component 735 as described with reference to FIG. 7.

At 1220, the method may include using a transformer based machine learning model to generate the attribute embedding and the entity embedding. The operations of 1220 may be performed in accordance with examples as disclosed herein. In some examples, aspects of the operations of 1220 may be performed by an entity embedding component 740 as described with reference to FIG. 7.

At 1225, the method may include generating an entity embedding based on the attribute embedding for each attribute of the first set of attributes associated with the first data entity. The operations of 1225 may be performed in accordance with examples as disclosed herein. In some examples, aspects of the operations of 1225 may be performed by an entity embedding component 740 as described with reference to FIG. 7.

At 1230, the method may include generating a sampling distribution using an attention layer that receives the attribute embedding for each attribute of the first set of attributes as input. The operations of 1230 may be performed in accordance with examples as disclosed herein. In some examples, aspects of the operations of 1230 may be performed by an entity embedding component 740 as described with reference to FIG. 7.

At 1235, the method may include sampling the sampling distribution to generate the entity embedding. The operations of 1235 may be performed in accordance with examples as disclosed herein. In some examples, aspects of the operations of 1235 may be performed by an entity embedding component 740 as described with reference to FIG. 7.

At 1240, the method may include parameterizing the topic characteristic for each data entity of the first set of data entities and the structural characteristic for each attribute of the first set of attributes in the machine learning model by generating the attribute embedding and the entity embedding for each data entity of the first set of data entities. The operations of 1240 may be performed in accordance with examples as disclosed herein. In some examples, aspects of the operations of 1240 may be performed by a parameterization component 745 as described with reference to FIG. 7.

A method for training a machine learning model is described. The method may include receiving a corpus of training data including a plurality of data entity schemas, wherein each data entity schema defines a respective set of attributes for a respective set of data entities corresponding to each data entity schema, wherein a first data entity of a first set of data entities corresponding to a first data entity schema is associated with a topic characteristic based on a first set of attributes defined by the first data entity schema, and wherein a first attribute of the first set of attributes is associated with a structural characteristic that is common across each of the first set of data entities, identifying, for each attribute of the first set of attributes, a respective attribute type identifier, generating, for each attribute of the first set of attributes corresponding to the first data entity, an attribute embedding based on the respective attribute type identifier and an attribute value for each attribute, generating an entity embedding based on the attribute embedding for each attribute of the first set of attributes associated with the first data entity, and parameterizing the topic characteristic for each data entity of the first set of data entities and the structural characteristic for each attribute of the first set of attributes in the machine learning model by generating the attribute embedding and the entity embedding for each data entity of the first set of data entities.

An apparatus for training a machine learning model is described. The apparatus may include a processor, memory coupled with the processor, and instructions stored in the memory. The instructions may be executable by the processor to cause the apparatus to receive a corpus of training data including a plurality of data entity schemas, wherein each data entity schema defines a respective set of attributes for a respective set of data entities corresponding to each data entity schema, wherein a first data entity of a first set of data entities corresponding to a first data entity schema is associated with a topic characteristic based on a first set of attributes defined by the first data entity schema, and wherein a first attribute of the first set of attributes is associated with a structural characteristic that is common across each of the first set of data entities, identify, for each attribute of the first set of attributes, a respective attribute type identifier, generating, for each attribute of the first set of attributes correspond to the first data entity, an attribute embedding based on the respective attribute type identifier and an attribute value for each attribute, generate an entity embedding based on the attribute embedding for each attribute of the first set of attributes associated with the first data entity, and parameterize the topic characteristic for each data entity of the first set of data entities and the structural characteristic for each attribute of the first set of attributes in the machine learning model by generating the attribute embedding and the entity embedding for each data entity of the first set of data entities.

Another apparatus for training a machine learning model is described. The apparatus may include means for receiving a corpus of training data including a plurality of data entity schemas, wherein each data entity schema defines a respective set of attributes for a respective set of data entities corresponding to each data entity schema, wherein a first data entity of a first set of data entities corresponding to a first data entity schema is associated with a topic characteristic based on a first set of attributes defined by the first data entity schema, and wherein a first attribute of the first set of attributes is associated with a structural characteristic that is common across each of the first set of data entities, means for identifying, for each attribute of the first set of attributes, a respective attribute type identifier, means for generating, for each attribute of the first set of attributes corresponding to the first data entity, an attribute embedding based on the respective attribute type identifier and an attribute value for each attribute, means for generating an entity embedding based on the attribute embedding for each attribute of the first set of attributes associated with the first data entity, and means for parameterizing the topic characteristic for each data entity of the first set of data entities and the structural characteristic for each attribute of the first set of attributes in the machine learning model by generating the attribute embedding and the entity embedding for each data entity of the first set of data entities.

A non-transitory computer-readable medium storing code for training a machine learning model is described. The code may include instructions executable by a processor to receive a corpus of training data including a plurality of data entity schemas, wherein each data entity schema defines a respective set of attributes for a respective set of data entities corresponding to each data entity schema, wherein a first data entity of a first set of data entities corresponding to a first data entity schema is associated with a topic characteristic based on a first set of attributes defined by the first data entity schema, and wherein a first attribute of the first set of attributes is associated with a structural characteristic that is common across each of the first set of data entities, identify, for each attribute of the first set of attributes, a respective attribute type identifier, generating, for each attribute of the first set of attributes correspond to the first data entity, an attribute embedding based on the respective attribute type identifier and an attribute value for each attribute, generate an entity embedding based on the attribute embedding for each attribute of the first set of attributes associated with the first data entity, and parameterize the topic characteristic for each data entity of the first set of data entities and the structural characteristic for each attribute of the first set of attributes in the machine learning model by generating the attribute embedding and the entity embedding for each data entity of the first set of data entities.

Some examples of the method, apparatuses, and non-transitory computer-readable medium described herein may further include operations, features, means, or instructions for receiving an input that corresponds to a data entity and an indication of an attribute type identifier and generating, by the machine learning model, an output that includes a value corresponding to the attribute type identifier based at least in part on the input.

In some examples of the method, apparatuses, and non-transitory computer-readable medium described herein, generating, by the machine learning model, an input embedding based at least in part on the input, wherein the output may be generated based at least in part on the input embedding and the indication of the attribute type identifier.

In some examples of the method, apparatuses, and non-transitory computer-readable medium described herein, identifying the respective attribute type identifier may include operations, features, means, or instructions for identifying, for each attribute, a column name of a column associated with each attribute in a data table corresponding to the first data entity schema and generating the respective attribute type identifier based on the column name of the column, wherein each row of the data table corresponds to a respective data entity of the first set of data entities.

Some examples of the method, apparatuses, and non-transitory computer-readable medium described herein may further include operations, features, means, or instructions for using a transformer based machine learning model to generate the attribute embedding and the entity embedding.

In some examples of the method, apparatuses, and non-transitory computer-readable medium described herein, generating the entity embedding may include operations, features, means, or instructions for generating a sampling distribution using an attention layer that receives the attribute embedding for each attribute of the first set of attributes as input and sampling the sampling distribution to generate the entity embedding.

Some examples of the method, apparatuses, and non-transitory computer-readable medium described herein may further include operations, features, means, or instructions for concatenating the respective attribute type identifier and the attribute value for each attribute, wherein the attribute embedding may be generated based on the concatenated respective attribute type identifier and the attribute value.

In some examples of the method, apparatuses, and non-transitory computer-readable medium described herein, generating, for each token of an attribute value for a first attribute, a token embedding, wherein the attribute embedding for the attribute value may be generated based at least in part on each token embedding for the attribute value.

Some examples of the method, apparatuses, and non-transitory computer-readable medium described herein may further include operations, features, means, or instructions for identifying that an attribute value for a second attribute references a second data entity of a second data entity schema of the plurality of data entity schemas and using, for the attribute embedding for the second attribute, the entity embedding that may be generated for the second data entity, wherein the entity embedding for the first data entity may be generated based at least in part on the entity embedding for the second data entity.

Some examples of the method, apparatuses, and non-transitory computer-readable medium described herein may further include operations, features, means, or instructions for identifying that the attribute value for a second attribute references set of related attribute values and generating the attribute embedding for each related attribute value of the set of related attribute values, wherein each of the attribute embeddings for each related attribute value may be based on the identified attribute type identifier and the entity embedding may be generated based on the each of the attribute embeddings for each related attribute value.

It should be noted that the methods described above describe possible implementations, and that the operations and the steps may be rearranged or otherwise modified and that other implementations are possible. Furthermore, aspects from two or more of the methods may be combined.

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

Information and signals described herein may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can comprise RAM, ROM, electrically erasable programmable ROM (EEPROM), compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein, but is to be accorded the broadest scope consistent with the principles and novel features disclosed herein.

What is claimed is:

1. A method for training a machine learning model, comprising:
receiving a corpus of training data including a plurality of data entity schemas, wherein each data entity schema defines a respective set of attributes for a respective set of data entities corresponding to each data entity schema, wherein a first data entity of a first set of data entities corresponding to a first data entity schema is associated with a topic characteristic based on a first set of attributes defined by the first data entity schema, and wherein a first attribute of the first set of attributes is associated with a structural characteristic that is common across each of the first set of data entities;
identifying, for each attribute of the first set of attributes, a respective attribute type identifier;
generating, for each attribute of the first set of attributes corresponding to the first data entity, an attribute embedding based on the respective attribute type identifier and an attribute value for each attribute;
generating an entity embedding based on the attribute embedding for each attribute of the first set of attributes associated with the first data entity; and
parameterizing the topic characteristic for each data entity of the first set of data entities and the structural characteristic for each attribute of the first set of attributes in the machine learning model by generating the attribute embedding and the entity embedding for each data entity of the first set of data entities.

2. The method of claim 1, further comprising:
receiving an input that corresponds to a data entity and an indication of an attribute type identifier; and
generating, by the machine learning model, an output that includes a value corresponding to the attribute type identifier based at least in part on the input.

3. The method of claim 2, further comprising:
generating, by the machine learning model, an input embedding based at least in part on the input, wherein the output is generated based at least in part on the input embedding and the indication of the attribute type identifier.

4. The method of claim 1, wherein identifying the respective attribute type identifier comprises:
identifying, for each attribute, a column name of a column associated with each attribute in a data table corresponding to the first data entity schema; and
generating the respective attribute type identifier based on the column name of the column, wherein each row of the data table corresponds to a respective data entity of the first set of data entities.

5. The method of claim 1, further comprising:
using a transformer based machine learning model to generate the attribute embedding and the entity embedding.

6. The method of claim 1, wherein generating the entity embedding comprises:
generating a sampling distribution using an attention layer that receives the attribute embedding for each attribute of the first set of attributes as input; and
sampling the sampling distribution to generate the entity embedding.

7. The method of claim 1, further comprising:
concatenating the respective attribute type identifier and the attribute value for each attribute, wherein the attribute embedding is generated based on the concatenated respective attribute type identifier and the attribute value.

8. The method of claim 1, further comprising:
generating, for each token of an attribute value for a first attribute, a token embedding, wherein the attribute embedding for the attribute value is generated based at least in part on each token embedding for the attribute value.

9. The method of claim 1, further comprising:
identifying that an attribute value for a second attribute references a second data entity of a second data entity schema of the plurality of data entity schemas; and
using, for the attribute embedding for the second attribute, the entity embedding that is generated for the second data entity, wherein the entity embedding for the first data entity is generated based at least in part on the entity embedding for the second data entity.

10. The method of claim 1, further comprising:
identifying that the attribute value for a second attribute references set of related attribute values; and
generating the attribute embedding for each related attribute value of the set of related attribute values, wherein each of the attribute embeddings for each related attribute value is based on the identified attribute type identifier and the entity embedding is generated based on the each of the attribute embeddings for each related attribute value.

11. An apparatus for training a machine learning model, comprising:
a processor;
memory coupled with the processor; and
instructions stored in the memory and executable by the processor to cause the apparatus to:
receive a corpus of training data including a plurality of data entity schemas, wherein each data entity schema defines a respective set of attributes for a respective set of data entities corresponding to each data entity schema, wherein a first data entity of a first set of data entities corresponding to a first data entity schema is associated with a topic characteristic based on a first set of attributes defined by the first data entity schema, and wherein a first attribute of the first set of attributes is associated with a structural characteristic that is common across each of the first set of data entities;
identify, for each attribute of the first set of attributes, a respective attribute type identifier;
generating, for each attribute of the first set of attributes correspond to the first data entity, an attribute embedding based on the respective attribute type identifier and an attribute value for each attribute;
generate an entity embedding based on the attribute embedding for each attribute of the first set of attributes associated with the first data entity; and
parameterize the topic characteristic for each data entity of the first set of data entities and the structural characteristic for each attribute of the first set of attributes in the machine learning model by generating the attribute embedding and the entity embedding for each data entity of the first set of data entities.

12. The apparatus of claim 11, wherein the instructions are further executable by the processor to cause the apparatus to:
receive an input that corresponds to a data entity and an indication of an attribute type identifier; and
generate, by the machine learning model, an output that include a value corresponding to the attribute type identifier based at least in part on the input.

13. The apparatus of claim 12, wherein the instructions are further executable by the processor to cause the apparatus to:
generate, by the machine learning model, an input embedding based at least in part on the input, wherein the output is generated based at least in part on the input embedding and the indication of the attribute type identifier.

14. The apparatus of claim 11, wherein the instructions to identify the respective attribute type identifier are executable by the processor to cause the apparatus to:
identify, for each attribute, a column name of a column associated with each attribute in a data table corresponding to the first data entity schema; and
generate the respective attribute type identifier based on the column name of the column, wherein each row of the data table corresponds to a respective data entity of the first set of data entities.

15. The apparatus of claim 11, wherein the instructions are further executable by the processor to cause the apparatus to:
use a transformer based machine learning model to generate the attribute embedding and the entity embedding.

16. A non-transitory computer-readable medium storing code for training a machine learning model, the code comprising instructions executable by a processor to:
receive a corpus of training data including a plurality of data entity schemas, wherein each data entity schema defines a respective set of attributes for a respective set of data entities corresponding to each data entity schema, wherein a first data entity of a first set of data entities corresponding to a first data entity schema is associated with a topic characteristic based on a first set of attributes defined by the first data entity schema, and wherein a first attribute of the first set of attributes is associated with a structural characteristic that is common across each of the first set of data entities;
identify, for each attribute of the first set of attributes, a respective attribute type identifier;
generate, for each attribute of the first set of attributes correspond to the first data entity, an attribute embedding based on the respective attribute type identifier and an attribute value for each attribute;
generate an entity embedding based on the attribute embedding for each attribute of the first set of attributes associated with the first data entity; and
parameterize the topic characteristic for each data entity of the first set of data entities and the structural characteristic for each attribute of the first set of attributes in the machine learning model by generating the attribute embedding and the entity embedding for each data entity of the first set of data entities.

17. The non-transitory computer-readable medium of claim 16, wherein the instructions are further executable by the processor to:
receive an input that corresponds to a data entity and an indication of an attribute type identifier; and
generate, by the machine learning model, an output that include a value corresponding to the attribute type identifier based at least in part on the input.

18. The non-transitory computer-readable medium of claim 17, wherein the instructions are further executable by the processor to:
generate, by the machine learning model, an input embedding based at least in part on the input, wherein the output is generated based at least in part on the input embedding and the indication of the attribute type identifier.

19. The non-transitory computer-readable medium of claim 16, wherein the instructions to identify the respective attribute type identifier are executable by the processor to:
identify, for each attribute, a column name of a column associated with each attribute in a data table corresponding to the first data entity schema; and
generate the respective attribute type identifier based on the column name of the column, wherein each row of the data table corresponds to a respective data entity of the first set of data entities.

20. The non-transitory computer-readable medium of claim 16, wherein the instructions are further executable by the processor to:
use a transformer based machine learning model to generate the attribute embedding and the entity embedding.
